(19) United States
(12) Patent Application Publication
(10) Pub. No.: US 2025/0370571 A1
(43) Pub. Date: Dec. 4, 2025

(54) TOUCH SENSOR PANEL WITH REDUCED AMBIENT LIGHT INTERFERENCE

(71) Applicant: Apple Inc., Cupertino, CA (US)

(72) Inventors: Bin HUANG, Sunnyvale, CA (US); Christoph H. KRAH, Cupertino, CA (US); Stanley B. WANG, Cupertino, CA (US); Luya ZHANG, Sunnyvale, CA (US)

(21) Appl. No.: 19/040,337

(22) Filed: Jan. 29, 2025

Related U.S. Application Data
(60) Provisional application No. 63/652,595, filed on May 28, 2024.

(51) Int. Cl. G06F 3/042; G06F 3/041

(52) U.S. Cl. CPC G06F 3/0421; G06F 3/0412; G06F 3/0416

(57) ABSTRACT

A touch sensor panel can include a micro-driver region corresponding to a chiplet micro-driver and a photodetector region corresponding to a photodetector. A first layer of opaque material in the micro-driver region and the photodetector region can include a plurality of openings in the micro-driver region and the photodetector region. The plurality of openings can include a first opening in the micro-driver region opposite the chiplet micro-driver and a second opening in the photodetector region opposite the photodetector. The touch sensor panel can include a plurality of metal layers between the first layer of opaque material and the chiplet micro-driver and the photodetector. One or more first portions of one or more of the plurality of metal layers can be disposed opposite the first opening and be configured to at least partially block light entering the first opening from being incident on the chiplet micro-driver.

### CROSS-REFERENCE TO RELATED APPLICATIONS

This application claims the benefit of U.S. Provisional Application No. 63/652,595, filed May 28, 2024, the content of which is herein incorporated by reference in its entirety for all purposes.

### FIELD OF THE DISCLOSURE

This relates generally to an electronic device including touch and/or proximity sensing and including optical sensing, and more particularly to an electronic device including integrated micro circuitry configurable for optical sensing and touch and/or proximity sensing.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular, are popular because of their case and versatility of operation as well as their declining price. Touch screens can include a touch sensor panel, which can be a clear panel with a touch-sensitive surface, and a display device such as a liquid crystal display (LCD), light emitting diode (LED) display or organic light emitting diode (OLED) display that can be positioned partially or fully behind the panel so that the touch-sensitive surface can cover at least a portion of the viewable area of the display device. Touch screens can allow a user to perform various functions by touching the touch sensor panel using a finger, stylus or other object at a location often dictated by a user interface (UI) being displayed by the display device. In general, touch screens can recognize a touch and the position of the touch on the touch sensor panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing electric fields used to detect touch can extend beyond the surface of the display, and objects approaching near the surface may be detected near the surface without actually touching the surface.

A touch sensor panel can include ambient light sensors that include photodetectors. Ambient light sensing circuitry is coupled to the photodetectors to measure ambient light incident on the panel. The touch sensor panel uses the ambient light measurements to perform a variety of functions such as regulating display brightness.

### SUMMARY OF THE DISCLOSURE

This relates generally to an electronic device including touch and/or proximity sensing and including optical sensing, and more particularly to an electronic device including integrated micro circuitry configurable for optical sensing and touch and/or proximity sensing. Some examples of the disclosure are directed to a touch sensor panel that can shield sensitive touch sensor panel circuitry from light interference while enabling photodetectors and preventing display artifacts resulting from irregular patterns shielding and/openings. A touch sensor panel can include a micro-driver region corresponding to a chiplet micro-driver and a photodetector region corresponding to a photodetector. A first layer of opaque material in the micro-driver region and the photodetector region can include a plurality of openings in the micro-driver region and the photodetector region. The plurality of openings can include a first opening in the micro-driver region opposite the chiplet micro-driver and a second opening in the photodetector region opposite the photodetector. The touch sensor panel can include a plurality of metal layers between the first layer of opaque material and the chiplet micro-driver and the photodetector. One or more first portions of one or more of the plurality of metal layers can be disposed opposite the first opening and be configured to at least partially block light entering the first opening from being incident on the chiplet micro-driver.

In some examples, the one or more first portions of the one or more of the plurality of metal layers can include a first routing trace in a first metal layer and a second routing trace in a second metal layer, different from the first metal layer, the first routing trace overlapping the second routing trace by a first predetermined amount. In some examples, a first metal layer of the one or more of the plurality of metal layers can be a micro-driver metal layer configured to route micro-driver signals and a second metal layer of the one or more of the plurality of metal layers can be a panel metal layer configured to route signals other than micro-driver signals. In some examples, the plurality of metal layers can include a plurality of openings opposite the second opening to enable the light entering the second opening to be incident on the photodetector.

### BRIEF DESCRIPTION OF THE DRAWINGS

FIGS. 1A-1E illustrate example systems in which an integrated touch screen according to examples of the disclosure may be implemented.

FIG. 2A is a block diagram of an example computing system that illustrates one implementation of an example integrated touch screen according to examples of the disclosure.

FIG. 2B illustrates an example touch sensing configuration including various associated capacitances according to examples of the disclosure.

FIG. 2C illustrates an example equivalent circuit diagram of an example touch sensing configuration according to examples of the disclosure.

FIGS. 3A-3B illustrate example stack-ups of an integrated touch screen according to examples of the disclosure.

FIGS. 4A and 4B illustrate portions of an example touch sensor panel according to examples of the disclosure.

FIG. 5 illustrates a representation of an example stack-up of routing metals of the touch sensor panel according to examples of the disclosure.

FIGS. 6A and 6B illustrate example cross-sections of portions of the touch sensor panel having an opening in the photodetector region according to examples of the disclosure.

FIGS. 7A and 7B illustrate examples of spatial arrangements of portions of metal layers forming routing traces, according to examples of the disclosure.

FIG. 8 illustrates an example cross-section of an opening in the micro-driver region according to an example of the disclosure.

FIGS. 9A and 9B illustrate example portions of a touch sensor panel according to an example of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates generally to an electronic device including touch and/or proximity sensing and including optical sensing, and more particularly to an electronic device including integrated micro circuitry configurable for optical sensing and touch and/or proximity sensing. As described herein, touch and/or proximity sensing primarily refers to capacitive touch and/or proximity sensing, and optical sensing refers to light sensing operations including ambient light sensing and optical touch and/or proximity detection.

Some examples of the disclosure are directed to a touch sensor panel that can shield sensitive touch sensor panel circuitry from light interference while enabling photodetectors to receive light and preventing display artefacts resulting from irregular patterns of shielding and/or openings. A touch sensor panel can include a micro-driver region corresponding to a chiplet micro-driver and a photodetector region corresponding to a photodetector. A first layer of opaque material in the micro-driver region and the photodetector region can include a plurality of openings in the micro-driver region and the photodetector region. The plurality of openings can include a first opening in the micro-driver region opposite the chiplet micro-driver and a second opening in the photodetector region opposite the photodetector. The touch sensor panel can include a plurality of metal layers between the first layer of opaque material and the chiplet micro-driver and the photodetector. One or more first portions of one or more of the plurality of metal layers can be disposed opposite the first opening and be configured to at least partially block light entering the first opening from being incident on the chiplet micro-driver.

In some examples, the one or more first portions of the one or more of the plurality of metal layers can include a first routing trace in a first metal layer and a second routing trace in a second metal layer, different from the first metal layer, the first routing trace overlapping the second routing trace by a first predetermined amount. In some examples, a first metal layer of the one or more of the plurality of metal layers can be a micro-driver metal layer configured to route micro-driver signals and a second metal layer of the one or more of the plurality of metal layers can be a panel metal layer configured to route signals other than micro-driver signals. In some examples, the plurality of metal layers can include a plurality of openings opposite the second opening to enable the light entering the second opening to be incident on the photodetector.

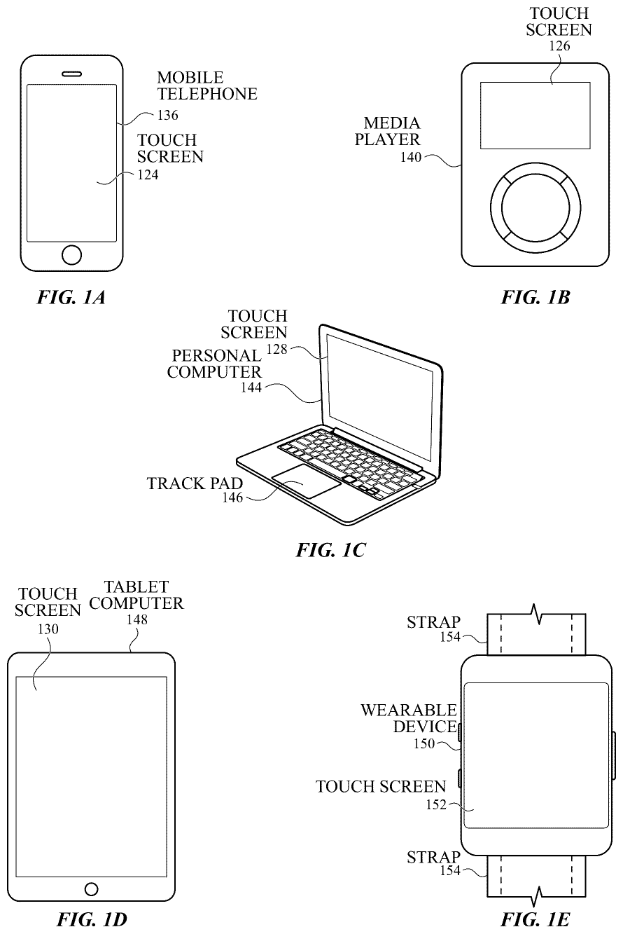

FIGS. 1A-1E illustrate example systems in which an integrated touch screen according to examples of the disclosure may be implemented. FIG. 1A illustrates an example mobile telephone 136 that includes an integrated touch screen 124. FIG. 1B illustrates an example digital media player 140 that includes an integrated touch screen 126. FIG. IC illustrates an example personal computer 144 that includes a trackpad 146 and an integrated touch screen 128. FIG. 1D illustrates an example tablet computer 148 that includes an integrated touch screen 130. FIG. 1E illustrates an example wearable device 150 (e.g., a watch) secured to the user by strap(s) 154 that includes an integrated touch screen 152. It is understood that the above integrated touch screens can be implemented in other devices as well. Additionally, it should be understood that although the disclosure herein primarily focuses on integrated touch screens, some of the disclosure is also applicable to touch sensor panels without a corresponding display.

In some examples, touch screens 124, 126, 128, 130 and 152 can be based on self-capacitance. A self-capacitance based touch system can include a matrix of small, individual plates of conductive material or groups of individual plates of conductive material forming larger conductive regions that can be referred to as touch node electrodes. For example, a touch screen can include a plurality of individual touch node electrodes, each touch node electrode identifying or representing a unique location (e.g., a touch node) on the touch screen at which touch or proximity is to be sensed, and each touch node electrode being electrically isolated from the other touch node electrodes in the touch screen/panel. Such a touch screen can be referred to as a pixelated self-capacitance touch screen, though it is understood that in some examples, the touch node electrodes on the touch screen can be used to perform scans other than self-capacitance scans on the touch screen (e.g., mutual capacitance scans). During operation, a touch node electrode can be stimulated with an AC waveform, and the self-capacitance to ground of the touch node electrode can be measured. As an object approaches the touch node electrode, the self-capacitance to ground of the touch node electrode can change (e.g., increase). This change in the self-capacitance of the touch node electrode can be detected and measured by the touch sensing system to determine the positions of multiple objects when they touch, or come in proximity to, the touch screen. In some examples, the touch node electrodes of a self-capacitance based touch system can be formed from rows and columns of conductive material, and changes in the self-capacitance to ground of the rows and columns can be detected, similar to above. In some examples, a touch screen can be multi-touch, single touch, projection scan, full-imaging multi-touch, capacitive touch, etc.

In some examples, touch screens 124, 126, 128, 130 and 152 can be based on mutual capacitance. A mutual capacitance based touch system can include electrodes arranged as drive and sense lines that may cross over each other on different layers, or may be adjacent to each other on the same layer. The crossing or adjacent locations can form touch nodes. During operation, the drive line can be stimulated with an AC waveform and the mutual capacitance of the touch node can be measured. As an object approaches the touch node, the mutual capacitance of the touch node can change (e.g., decrease). This change in the mutual capacitance of the touch node can be detected and measured by the touch sensing system to determine the positions of multiple objects when they touch, or come in proximity to, the touch screen. As described herein, in some examples, a mutual capacitance based touch system can form touch nodes from a matrix of small, individual plates of conductive material.

In some examples, touch screens 124, 126, 128 and 130 can be based on mutual capacitance and/or self-capacitance. The electrodes can be arranged as a matrix of small, individual plates of conductive material or as drive lines and sense lines, or in another pattern. The electrodes can be configurable for mutual capacitance or self-capacitance sensing or a combination of mutual and self-capacitance sensing. For example, in one mode of operation, electrodes can be configured to sense mutual capacitance between electrodes, and in a different mode of operation, electrodes can be configured to sense self-capacitance of electrodes. In some examples, some of the electrodes can be configured to sense mutual capacitance therebetween and some of the electrodes can be configured to sense self-capacitance thereof.

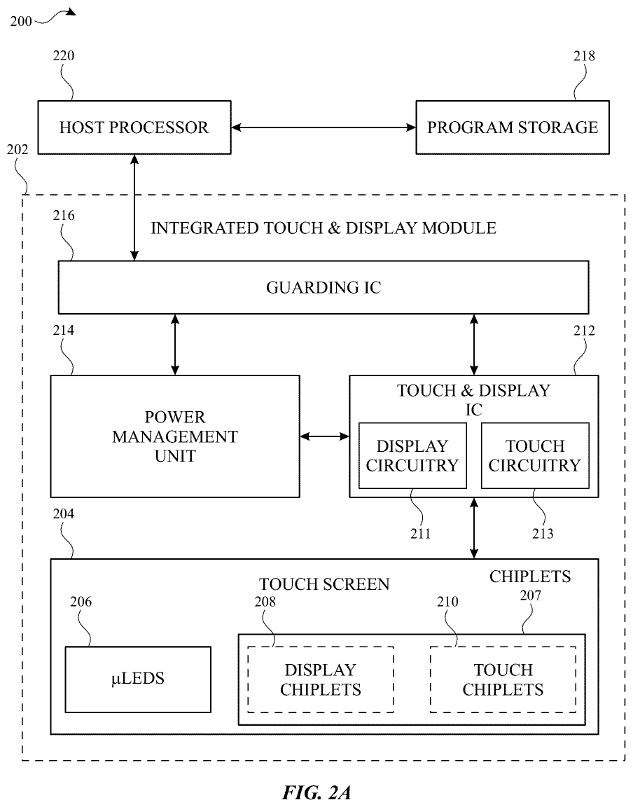

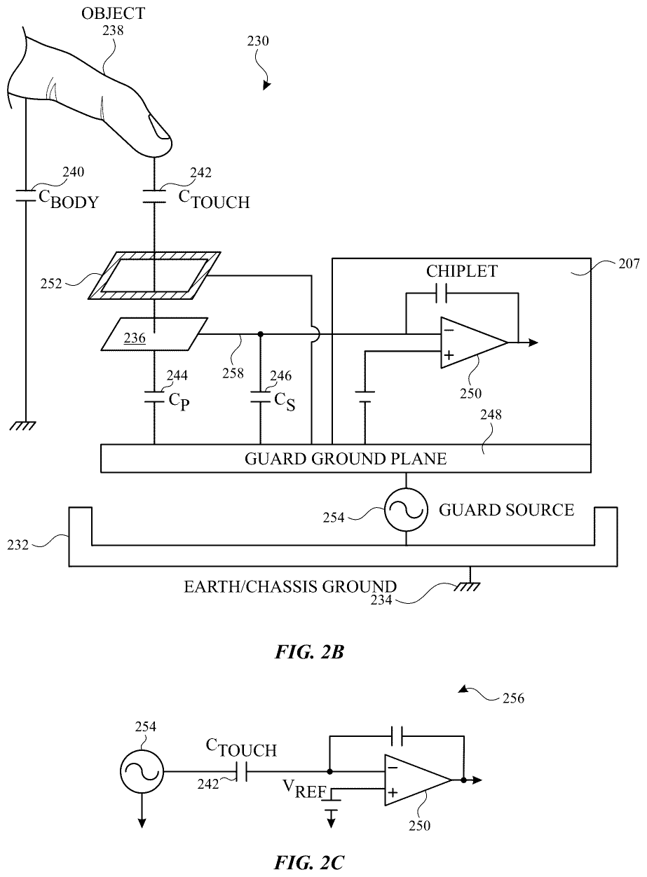

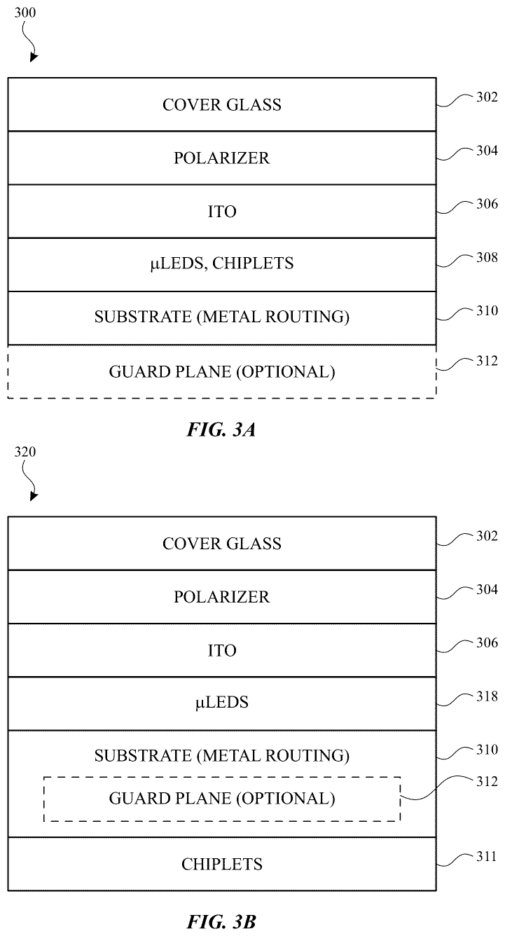

FIG. 2A is a block diagram of an example computing system 200 that illustrates one implementation of an example integrated touch screen 204 according to examples of the disclosure. As described in more detail herein, the integrated touch screen 204 can include light emitting diodes (LEDs), organic light emitting diodes (OLEDs), or micro-LEDs 206, one or more light detectors (e.g., photodetectors 408, not shown in FIG. 2A), and chiplets 207 (e.g., integrated chiplets including LED/OLED drivers, touch sensing circuitry and/or optical sensing circuitry). In some examples, the functionality of chiplets can be divided into separate display chiplets 208 (e.g., including LED/OLED drivers) and touch chiplets 210 (e.g., including touch sensing circuitry and/or optical sensing circuitry). Computing system 200 can be included in, for example, mobile telephone 136, digital media player 140, personal computer 144, tablet computer 148, wearable device 150 or any mobile or non-mobile computing device that includes a touch screen. Computing system 200 can include integrated touch and display module 202, host processor 220 and program storage 218. Integrated touch and display module 202 can include integrated touch screen 204 and integrated circuits for operation of integrated touch screen 204. In some examples, integrated touch and display module 202 can be formed on a single substrate with micro-LEDs 206 and chiplets 207 (or display chiplets 208 and/or touch chiplets 210) of integrated touch screen 204 on one side of the touch screen and integrated circuits controlling operation of micro-LEDs 206 and chiplets 207 mounted on an opposite side of the single substrate. Forming integrated touch and display module 202 in this way can provide for simplified manufacturing and assembly of devices with a touch screen. In some examples, the integrated touch and display module 202 can be formed on a single substrate with micro-LEDs 206 on one side of the substrate and chiplets 207 (or display chiplets 208 and/or touch chiplets 210) of integrated touch screen 204 and integrated circuits controlling operation of micro-LEDs 206 and chiplets 207 mounted on an opposite side of the single substrate.

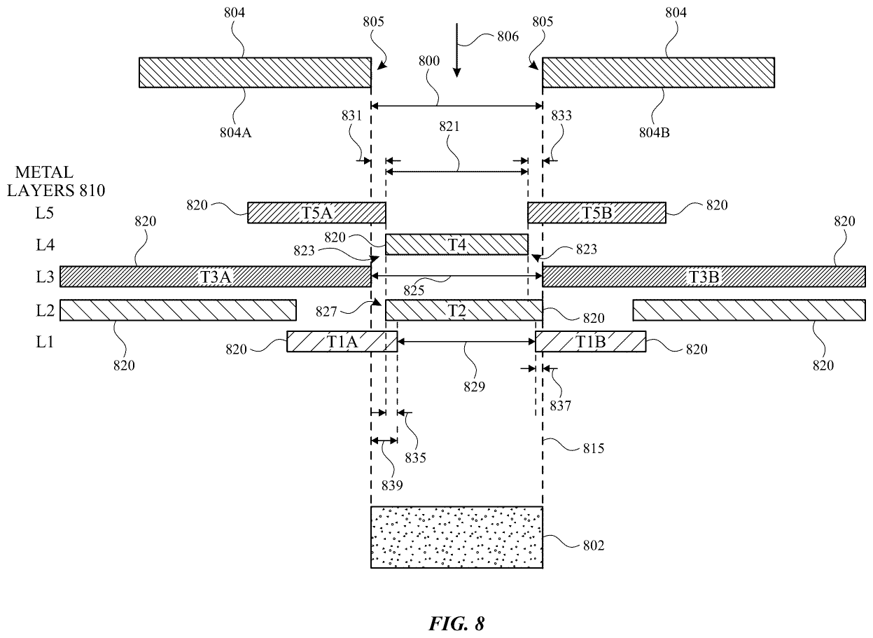

Integrated circuits for operation of integrated touch screen 204 can include an integrated touch and display integrated circuit (touch and display controller) 212, a power management unit (PMU) 214, and optionally a guard integrated circuit (guard IC) 216. As described in more detail herein, self-capacitance touch sensing performance can be improved (and parasitic capacitance effects reduced) by performing touch sensing operations in a different power domain than in the chassis power domain. In some examples, guard IC 216 can be used to operate integrated touch and display module 202 in a guard power domain during guarded touch operation and operate touch and display module 202 in the chassis power domain otherwise (e.g., during non-guarded touch operations or during display operations). Power management unit 214 can be an integrated circuit configured to provide the voltages necessary for the touch and display controller 212, including guard-referenced power supplies when operating in a guarded power domain. The touch and display controller 212 can include circuitry to perform touch sensing, optical sensing and display operations (e.g., according to the touch sensing, optical sensing and display operations illustrated in FIGS. 7A-7B). Although illustrated in FIG. 2A as a single integrated circuit, the various components and/or functionality of the touch and display controller 212 can be implemented with multiple circuits, elements, chips, and/or discrete components (e.g., a separate touch integrated circuit and a separate display integrated circuit with an integrated circuit to handle the handoff between the two).

The touch and display controller 212 can include display circuitry 211 to perform display operations. Display circuitry 211 can include hardware to process one or more still images and/or one or more video sequences for display on integrated touch screen 204. The display circuitry 211 can be configured to generate read memory operations to read the data representing the frame/video sequence from a memory (not shown) through a memory controller (not shown), for example, or can receive the data representing the frame/video sequence from host processor 220. The display circuitry 211 can be configured to perform various processing on the image data (e.g., still images, video sequences, etc.). In some examples, the display circuitry 211 can be configured to scale still images and to dither, scale and/or perform color space conversion on the frames of a video sequence. Display circuitry 211 can be configured to blend the still image frames and the video sequence frames to produce output frames for display. The display circuitry 211 can also be more generally referred to as a display controller, display pipe, display control unit, or display pipeline. The display control unit can be generally any hardware and/or firmware configured to prepare a frame for display from one or more sources (e.g., still images and/or video sequences). More particularly, the display circuitry 211 can be configured to retrieve source frames from one or more source buffers stored in memory, composite frames from the source buffers, and display the resulting frames on integrated touch screen 204. Accordingly, the display circuitry 211 can be configured to read one or more source buffers and composite the image data to generate the output frame. Display circuitry 211 can provide various control and data signals to the display, via chiplets 207 (or via display chiplets 208), including timing signals (e.g., one or more clock signals) and pixel selection signals. The timing signals can include a pixel clock that can indicate transmission of a pixel. The data signals can include color signals (e.g., red, green, blue) for micro-LEDs 206. The display circuitry can control integrated touch screen 204 in real-time, providing the data indicating the pixels to be displayed as the touch screen is displaying the image indicated by the frame. The interface to such an integrated touch screen 204 can be, for example, a video graphics array (VGA) interface, a high definition multimedia interface (HDMI), a mobile industry processor interface (MIPI), a digital video interface (DVI), an LCD/LED/OLED interface, a plasma interface, or any other suitable interface.

The touch and display controller 212 can include touch circuitry 213 to perform touch operations. Touch circuitry 213 can include one or more touch processors, peripherals (e.g., random access memory (RAM) or other types of memory or storage, watchdog timers and the like), and a touch controller. The touch controller can include, but is not limited to, channel scan logic (e.g., implemented in programmable logic circuits or as discrete logic circuits) which can provide configuration and control for touch sensing operations by chiplets 207 (or by touch chiplets 210). For example, touch chiplets 210 can be configured to drive, sense and/or ground touch node electrodes depending on the mode of touch sensing operations. Additionally or alternatively, the chiplets 207 (or touch chiplets 210) can be configured for optical sensing (e.g., using touch circuitry 213 of touch and display controller 212 or using separate circuitry and a separate controller for optical sensing operations). The mode of touch sensing and/or optical sensing operations can, in some examples, be determined by a scan plan stored in memory (e.g., RAM) in touch circuitry 213. The scan plan can provide a sequence of scan events to perform during a frame. The scan plan can also include information necessary for providing control signals to and programming chiplets 207 for the specific scan event to be performed, and for analyzing data from chiplets 207 according to the specific scan event to be performed. The scan events can include, but are not limited to, a mutual capacitance scan, a self-capacitance scan, a stylus scan, touch spectral analysis scan, a stylus spectral analysis scan, and an optical sensing scan. The channel scan logic or other circuitry in touch circuitry 213 can provide the stimulation signals at various frequencies and phases that can be selectively applied to the touch node electrodes of integrated touch screen 204 or used for demodulation, as described in more detail below. The touch circuitry 213 can also receive touch data from the chiplets 207 (or touch chiplets 210), store touch data in memory (e.g., RAM), and/or process touch data (e.g., by one or more touch processors or touch controller) to determine locations of touch and/or clean operating frequencies for touch sensing operations (e.g., spectral analysis). The touch circuitry 213 (or separate optical sensing circuitry) can also receive ambient light data from the chiplets 207 (or touch chiplets 210), store ambient light data in memory (e.g., RAM), and/or process ambient light data (e.g., by one or more touch processors or touch controller or an optical sensing processor/controller) to determine ambient light conditions.

Integrated touch screen 204 can be used to derive touch data at multiple discrete locations of the touch screen, referred to herein as touch nodes. For example, integrated touch screen 204 can include touch sensing circuitry that can include a capacitive sensing medium having a plurality of electrically isolated touch node electrodes. Touch node electrodes can be coupled to chiplets 207 (or touch chiplets 210) for touch sensing by sensing channel circuitry. As used herein, an electrical component “coupled to” or “connected to” another electrical component encompasses a direct or indirect connection providing electrical path for communication or operation between the coupled components. Thus, for example, touch node electrodes of integrated touch screen 204 may be directly connected to chiplets 207 or indirectly connected to chiplets 207 (e.g., connected to touch chiplets 210 via display chiplets 208), but in either case provided an electrical path for driving and/or sensing the touch node electrodes. Labeling the conductive plates (or groups of conductive plates) used to detect touch as touch node electrodes corresponding to touch nodes (discrete locations of the touch screen) can be particularly useful when integrated touch screen 204 is viewed as capturing an “image” of touch (or “touch image”). The touch image can be a two-dimensional representation of values indicating an amount of touch detected at each touch node electrode corresponding to a touch node in integrated touch screen 204. The pattern of touch nodes at which a touch occurred can be thought of as a touch image (e.g., a pattern of fingers touching the touch screen). In such examples, each touch node electrode in a pixelated touch screen can be sensed for the corresponding touch node represented in the touch image.

Host processor 220 can be connected to program storage 218 to execute instructions stored in program storage 218 (e.g., a non-transitory computer-readable storage medium). Host processor 220 can provide, for example, control and data signals so that touch and display controller 212 can generate a display image on integrated touch screen 204, such as a display image of a user interface (UI). Host processor 220 can also receive outputs from touch and display controller 212 (e.g., touch inputs from the one or more touch processors, ambient light information, etc.) and performing actions based on the outputs. The touch input can be used by computer programs stored in program storage 218 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 220 can also perform additional functions that may not be related to touch processing, optical sensing, and display.

Note that one or more of the functions described herein, including the configuration and operation of chiplets, can be performed by firmware stored in memory (e.g., one of the peripherals in touch and display controller 212) and executed by one or more processors (in touch and display controller 212), or stored in program storage 218 and executed by host processor 220. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding signals) that can contain or store the program for use by or in connection with the instruction execution system, apparatus, or device. The computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, universal serial bus (USB) memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

It is to be understood that the computing system 200 is not limited to the components and configuration of FIG. 2A, but can include other or additional components in multiple configurations according to various examples. Additionally, the components of computing system 200 can be included within a single device, or can be distributed between multiple devices. In some examples, PMU 214 and guard IC 216 can be integrated into a power management and guard integrated circuit. In some examples, the power management and guard integrated circuit can provide power supplies (e.g., guard referenced) and the guard signal to touch screen 204 directly rather than via touch and display IC 212. In some examples, touch and display IC 212 can be coupled to host processor 220 directly, and a portion of touch and display IC 212 in communication with chiplets 207 can be included in an isolation well (e.g., a deep N-well isolation) referenced to the guard signal from guard IC 216. In some examples, computing system 200 can include an energy storage device (e.g., a battery). In some examples, computing system 200 can include wired or wireless communication circuitry (e.g., Bluetooth, WiFi, etc.).

As described herein, in some examples integrated touch and display module 202 can perform touch sensing operations (e.g., self-capacitance scans) in a different power domain than in the chassis power domain. In some examples, integrated touch and display module 202 can perform non-guarded touch sensing operations (e.g., mutual capacitance scans) or display operations in the chassis power domain. The optical sensing operations may be performed in either the chassis power domain or another power domain (e.g., guarded power domain), depending on the timing of the optical sensing operations.

FIG. 2B illustrates an example touch sensing configuration 230 including various associated capacitances according to examples of the disclosure. In configuration 230 of FIG. 2B, the touch sensing circuitry of integrated touch screen 204 can be referenced to a guard ground rather than a chassis ground. Specifically, in configuration 230 of FIG. 2B, touch sensing circuitry (e.g., sense amplifier 250) in chiplet 207 (or touch chiplet 210) can be coupled to a touch node electrode 236 by a routing trace 258. Chiplet 207 can be disposed or fabricated on a substrate including a guard ground plane 248 (“guard plane”), which can represent a virtual ground plane of touch chiplet 210 that is different from chassis ground 234 (also referred to herein as earth ground or device ground). In particular, stimulation source 254 (“guard source”) disposed in in guard IC 216, for example, can be referenced to chassis ground 234, and can output a guard voltage (e.g., a guard stimulation signal, such as a square or trapezoid wave) that can establish the voltage at guard plane 248. In this manner, the guard plane 248 acting as a guard ground for chiplet 207 can be referenced to the guard voltage. Because chiplet 207 can be mounted on a substrate including guard plane 248, the sense amplifier in chiplet 207 can be referenced to the guard signal (and receive other guard-referenced voltages produced by PMU 214, for example), and can be isolated from chassis ground 234 by guard plane 248. In this way, chiplet 207 (or touch chiplet 210) can operate in the guard power domain, whereas the guard source 254 (e.g., in guard IC 216) can operate in the chassis power domain. Guard plane 248 can be any conductive material of a substrate on which chiplet 207 can be disposed or fabricated (e.g., silver, copper, gold, etc.). For example, chiplet 207 may be assembled on a printed circuit board (PCB), and may be referenced to the PCB ground plane 248 driven, during guarded self-capacitance scans, by guard source 254. Guard source 254 can be implemented, for example, using a waveform generator (e.g., generating arbitrary waveforms, such as a square wave referenced to chassis ground 234) whose output can be inputted in to a digital-to-analog converter (DAC). Analog output from the DAC can be provided to a linear buffer (e.g., with unity or some other gain) whose output can correspond to the output of guard source 254.

Additionally, guard plane 248 can be disposed between touch node electrode 236 and chassis 232 (or, more generally, chassis ground 234), and guard plane 248 can be disposed between a routing trace that couples touch node electrode 236 to chiplet 207 and chassis 232 (or, more generally, chassis ground 234). Thus, guard plane 248 can similarly isolate touch node electrode 236 and routing trace 258 that couples touch node electrode 236 to chiplet 207 from chassis ground 234. Guard plane 248 can reduce or eliminate parasitic or stray capacitances that may exist between touch node electrode 236 and chassis ground 234, as will be described below. Optionally, a guard plane can be included in a layer above the touch node electrodes and/or between touch node electrodes (e.g., as illustrated by guard plane 252) and can be referenced to the same guard voltage. Guard plane 252 can include openings corresponding to touch node electrodes to enable detection of touch activity on the touch sensor panel (or proximity activity) while guarding the touch node electrodes and routing from stray capacitances that can form due to a touch or other stray capacitances. In some examples, the material(s) out of which guard planes 248 and 252 are made can be different. For example, guard plane 252 above the touch node electrodes can be made of indium tin oxide (ITO), or another fully or partially transparent conductor), and guard planes 248 in the substrate (e.g., PCB) can be made of a different conductor, such as copper, aluminum, or another conductor that may or may not be transparent.

Various capacitances associated with touch and/or proximity detection using configuration 230 are also shown in FIG. 2B. Specifically, an object 238 (e.g., a finger) can be in touching or in proximity to touch node electrode 236. Object 238 can be grounded to earth ground 234 through capacitance 240 (e.g., C_{body}), which can represent a capacitance from object 238 through a user's body to earth ground 234. Capacitance 242 (e.g., C_{touch}) can represent a capacitance between object 238 and touch node electrode 236, and can be the capacitance of interest in determining how close object 238 is to touch node electrode 236. Typically, C_{body} 240 can be significantly larger than C_{touch} 242 such that the equivalent series capacitance seen at touch node electrode 236 through object 238 can be approximately C_{touch} 242. Capacitance 242 can be measured by touch sensing circuitry (e.g., sense amplifier 250) included in chiplet 207 (or touch chiplet 210) to determine an amount of touch at touch node electrode 236 based on the sensed touch signal. As shown in FIG. 2B, touch sensing circuitry in chiplet 207 can be referenced to guard ground (with some DC biasing provided by the chiplet 207 and/or PMU 214). In some examples, capacitance 244 (e.g., Cₚ) can be a parasitic capacitance between touch node electrode 236 and guard plane 248. Capacitance 246 (e.g., Cₛ) can be a stray capacitance between routing trace 258 coupled to touch node electrode 236 and guard plane 248, for example. In some examples, the impact of capacitances 244 and 246 on a sensed touch signal can be mitigated because guard plane 248 and touch sensing circuitry in chiplet 207 are all referenced to the virtual ground signal produced by guard source 254 during a guarded self-capacitance scan.

When guarded, the voltage at touch node electrode 236 and trace 258 can mirror or follow the voltage at guard plane 248, and thereby capacitances 244 and 246 can be reduced or eliminated from the touch measurements performed by chiplet 207 (or touch chiplet 210). Without stray capacitances 244 and 246 affecting the touch measurements, the offset in the output signal of sense amplifier 250 (e.g., when no touch is detected at touch node electrode 236) can be greatly reduced or eliminated, which can increase the signal to noise ratio and/or the dynamic range of sense circuitry in chiplet 207. This, in turn, can improve the ability of touch sensing circuitry in chiplet 207 to detect a greater range of touch at touch node electrode 236, and to accurately detect smaller capacitances C_{touch} 242 (and, thus, to accurately detect proximity activity at touch node electrode 236 at larger distances). Additionally, with a near-zero offset output signal from touch sensing circuitry in chiplet 207, the effects of drift due to environmental changes (e.g., temperature changes) can be greatly reduced. For example, if the signal out of sense amplifier 250 consumes 50% of its dynamic range due to undesirable/un-guarded stray capacitances in the system, and the analog front end (AFE) gain changes by 10% due to temperature, the sense amplifier 250 output may drift by 5% and the effective signal-to-noise ratio (SNR) can be limited to 26 dB. By reducing the undesirable/un-guarded stray capacitances by 20 dB, the effective SNR can be improved from 26 dB to 46 dB.

FIG. 2C illustrates an example equivalent circuit diagram of an example touch sensing configuration 256 according to examples of the disclosure. As described herein, guarding can reduce or eliminate capacitances 244 and 246 from the touch measurements performed by touch sensing circuitry in chiplet 207. As a result, the sense amplifier 250 can simply detect C_{touch} 242, which can appear as a virtual mutual capacitance between object 238 and touch node electrode 236. Specifically, object 238 can appear to be stimulated (e.g., via C_{body} 240) by guard source 254, and object 238 can have C_{touch}242 between it and the inverting input of sense amplifier 250. Changes in C_{touch} 242 can, therefore, be sensed by sense amplifier 250 as changes in the virtual mutual capacitance C_{touch} 242 between object 238 and sense amplifier 250. As such, the offset in the output signal of sense amplifier 250 (e.g., when no touch is detected at touch node electrode 236) can be greatly reduced or eliminated, as described above. As a result, sense amplifier 250 (e.g., the input stage of touch sensing circuitry of chiplet 207) need not support as great a dynamic input range that self-capacitance sense circuitry might otherwise need to support in circumstances/configurations that do not exhibit the virtual mutual capacitance effect described here.

Because the self-capacitance measurements of touch node electrodes in self-capacitance based touch screen configurations can exhibit the virtual mutual capacitance characteristics described above, chiplet 207 can be designed with a simpler sensing architecture to support both self-capacitance measurements and mutual capacitance measurements.

Referring back to FIG. 2A, integrated touch screen 204 can be integrated such that touch sensing circuit elements of the touch sensing system can be integrated with the display stack-up and some circuit elements can be shared between touch and display operations. It is noted that circuit elements are not limited to whole circuit components, such as a whole capacitor, a whole transistor, etc., but can include portions of circuitry, such as a conductive plate.

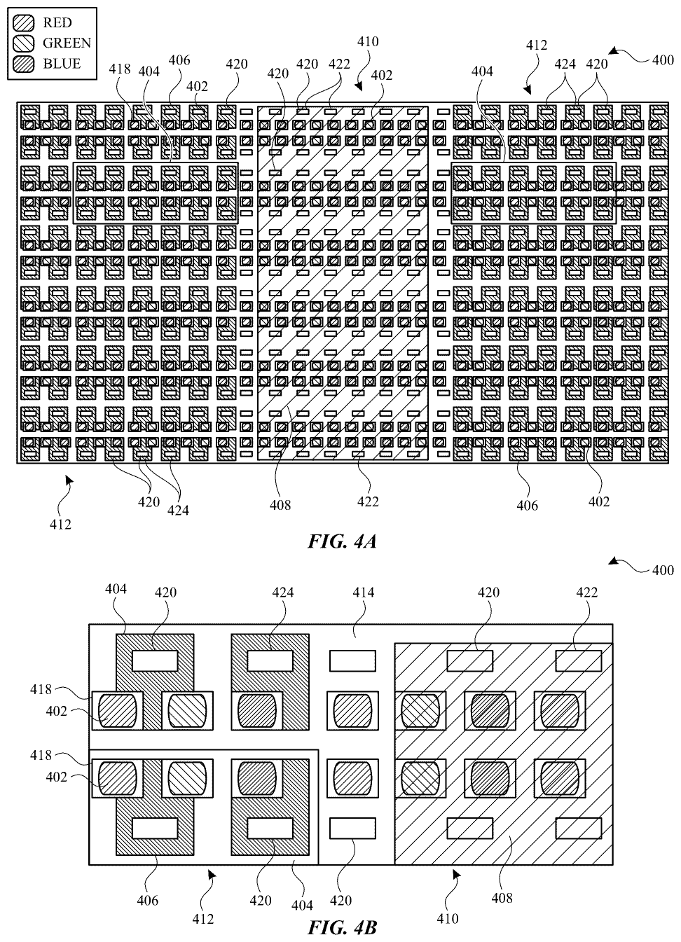

FIGS. 3A-3B illustrate example stack-ups of an integrated touch screen according to examples of the disclosure. FIG. 3A illustrates an example stack-up of a touch screen including chiplets (or touch chiplets and display chiplets) in the visible area of the display. Integrated touch screen 300 comprises a substrate 310 (e.g., a printed circuit board) upon which chiplets 207 (or touch chiplets 210 and/or display chiplets 208), light detectors (e.g., photodetectors 408), and micro-LEDs 206 can be mounted in touch and display circuit layer 308. In some examples, the chiplets 207 and/or micro-LEDs 206 can be partially or fully embedded in the substrate (e.g., the components can be placed in depressions in the substrate). In some examples, the chiplets 207 can be mounted on one and/or both sides of substrate 310. For example, some or all of the chiplets 207 can be mounted on a second side of substrate 310 (or some or all of the touch chiplets 210 and/or some or all of the display chiplets 208 can be mounted on a second side of substrate 310). In some examples, the chiplets can be disposed on the second side of the substrate (opposite the first side of the substrate including micro-LEDs 206). FIG. 3B illustrates an example stack-up of a touch screen including chiplets (or touch chiplets and/or display chiplets) outside the visible area of the display. Unlike the stack-up of integrated touch screen 300, in which chiplets 207 and micro-LEDs 206 can be mounted in touch and display circuit layer 308, stack-up of integrated touch screen 320 can include chiplets mounted in a touch and display circuit layer 311 on a second (bottom) side of substrate 310 different than the micro-LEDs 206 (and/or light detectors, such as photodetectors 408) mounted on in a display pixel layer 318 on a first (top, visible) side of substrate 310. In some examples, placing the chiplets on the second side of the substrate can allow for uniform spacing of the micro-LEDs and/or increased density of micro-LEDs on the first side of substrate 310.

The substrate 310 can include routing traces in one or more layers to route signals between micro-LEDs 206, chiplets 207 and touch and display controller 212. Substrate 310 can also optionally include a guard plane 312 for guarded operation (e.g., corresponding to guard plane 248 in FIG. 2B). Although illustrated on the bottom of substrate 310 in FIG. 3A, guard plane 312 can be formed as a layer of substrate 310 other than the bottom layer (e.g., as illustrated in FIG. 3B in an internal layer of substrate 310).

After mounting micro-LEDs 206 and chiplets 207 in the touch and display circuit layer 308 in FIG. 3A (e.g., during a pick-and-place assembly), a planarization layer (e.g., transparent epoxy) can be deposited over the micro-LEDs 206 and chiplets 207. The planarization layer can be deposited over the micro-LEDs 206 in the display pixel layer 318 in the stack-up of FIG. 3B. A fully or partially transparent conductor layer 306 (e.g., ITO) can be deposited above planarized touch and display circuit layer 308 in FIG. 3A or above the display pixel layer 318 in FIG. 3B. Conductor layer 306 can include a pattern of individual conductor plates that can be used for touch and display functions of integrated touch screen 300. For example, individual conductor plates can be used as cathode terminals for micro-LEDs during display operations (and/or optical sensing operations) and groups of conductor plates can form touch node electrodes for touch operations. Polarizer 304 can be disposed above the transparent conductor layer 306 (optionally with another planarization layer disposed over the transparent conductor layer 306). Cover glass (or front crystal) 302 can be disposed over polarizer 304 and form the outer surface of integrated touch screen 300. The stack-up of integrated touch screens 300 and/or 320 can provide numerous benefits including reduced costs (e.g., due to simplified assembly of devices including integrated touch and display module 202 and a reduced number of integrated circuits by combining touch and display functionality into integrated touch and display controller 212), reduced stack-up height (sharing conductors eliminates a separate touch node electrode layer; integrating chiplets 207 (or touch chiplets 210 and display chiplets 208) into the stack-up on the same layer with the micro-LEDs does not add to the stack-up height for FIG. 3A), simplified support for guarded self-capacitance scans (by including touch circuitry 213 on integrated touch and display module 202 with a guard plane extending throughout the substrate of integrated touch and display module 202), and shrinking the border region around the touch screen (because routing can be done through the substrate rather than in the border regions).

### Touch Sensor Panel with Reduced Ambient Light Interference

A touch sensor panel can include ambient light sensors that include photodetectors. Ambient light sensing circuitry is coupled to the photodetectors to measure ambient light incident on the panel. The touch sensor panel can use the ambient light measurements to perform a variety of functions such as regulating display brightness for a touch screen including the touch sensor panel. While it can be desirable to increase light transmission through layers of the touch sensor panel for ambient light sensing at the photodetectors, the ambient light can interfere with other circuitry of the touch sensor panel, such as micro-driver circuitry (also referred to herein as “micro-drivers”). For example, micro-driver circuitry refers to micro-scale circuitry used for driving an image on a display of the touch screen including the touch sensor panel, performing touch sensing using the touch sensor panel, and/or optical sensing (e.g., by the photodetector). In particular, photons absorbed by chiplet micro-driver circuitry can generate leakage current and cause power increases, resulting in functionality and performance disruptions that can introduce errors (e.g., touch sensing errors, optical sensing errors and/or display errors.

In some cases, micro-drivers can be encapsulated or otherwise enclosed in a light proof package to shield sensitive circuitry from the ambient light. However, such a solution can be impractical due to the micro-scale size of the micro-driver circuitry, manufacturing complexity, and cost. Alternatively, a layer of opaque mask across the touch sensor panel can shield the micro-drivers from light, whereas openings in opaque mask in the photodetector regions of the panel can enable light to reach the photodetectors. However, the uneven distribution of openings in the opaque mask (e.g., only in the photodetector regions) can reduce optical performance for the touch sensor panel (e.g., introduction of display artifacts characteristic due to increased visibility of non-uniform patterns). Examples of the present disclosure therefore propose solutions for shielding sensitive touch sensor panel circuitry from ambient light interference while enabling the photodetectors to receive light and preventing display artifacts resulting from irregular patterns.

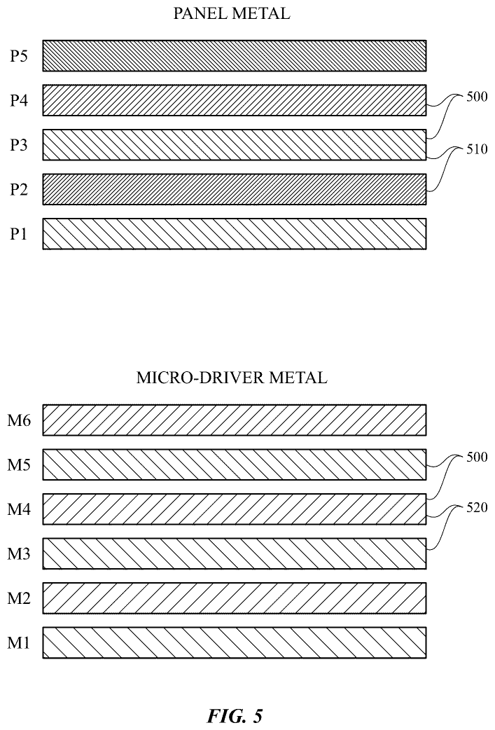

FIGS. 4A and 4B illustrate portions of an example touch sensor panel 400 according to an example of the disclosure. As described herein, some portions of the touch sensor panel 400 are described a photodetector region 410 or as a micro-driver region 412. A photodetector region 410 corresponds to a region of touch sensor panel 400 including a photodetector. A micro-driver region 412 corresponds to a region of the touch sensor panel 400 including a chiplet. It is understood that the photodetector regions 410 and/or micro-driver regions 412 illustrated herein are examples for the purpose of illustration. The number, size, and arrangement of photodetector regions 410 or as a micro-driver regions 412 shown is non-limiting.

As described above, in some examples, touch sensor panel 400 can be paired with a display device such as a liquid crystal display (LCD), light emitting diode (LED) display or organic light emitting diode (OLED) display and cover at least a portion of the viewable area of the display device to form a touch screen. In some examples, touch sensor panel 400 can be integrated with the display device such that the touch sensor panel 400 is a touch screen. As such, touch sensor panel 400 can include a plurality of LEDs, OLEDs, or micro-LEDs 402, and chiplets 404 (e.g., integrated chiplets including LED/OLED drivers, voltage sampling circuitry and/or touch sensing circuitry). Herein, chiplets 404 may also be referred to as micro-drivers 404 or chiplet micro-drivers 404. The micro-LEDs 402 may be arranged across the touch sensor panel 400 including in the photodetector region 410 and micro-driver regions 412. In some examples, the micro-LEDs 402 may be arranged across the touch sensor panel 400 in rows and columns of display pixels. In some examples, the micro-LEDs 402 may be disposed across the touch sensor panel 400 according to patterns other than rows and columns of display pixels. It is understood that the arrangement of micro-LEDs 402 shown in FIGS. 4A and 4B is non-limiting. The micro-LEDs 402 may include micro-LEDs configured to emit light having different colors, such as red, green, and blue micro-LEDs 402 illustrated in FIGS. 4A and 4B. Micro-LEDs 402 may be driven by chiplets 404, to which the micro-LEDs 402 may be electrically coupled via routing traces formed in one or more layers of the panel. In some examples, one or more of the metal layers 500 can be routed to micro-driver pads 406 (e.g., metal pads to which micro-drivers can be mounted during assembly) disposed opposite (e.g., beneath) at least some of the micro-LEDs 402. In some examples, micro-driver pads 406 disposed opposite micro-LEDs 402 are formed with portion of metal and/or routing traces that are configured to establish electrical connections between the chiplet micro-driver 404 and one or more micro-LEDs 402. In some examples, multiple micro-LEDs 402 may be driven by a corresponding micro-driver 404. It is understood that the size of the chiplet micro-driver 404 relative to the size of micro-LEDs 402 as depicted in the figures (e.g., FIGS. 4A and 4B) is merely illustrative and non-limiting, and that chiplet micro-drivers 404 can be smaller or larger than depicted. As described above in reference to the exemplary stack-up of FIG. 3A, chiplets including chiplet micro-drivers 404 may be mounted above the substrate 310, as are micro-LEDs 402, which are mounted in a layer above the chiplets micro-drivers 404, in some examples. In some examples, the mounting of chiplet micro-drivers 404 above the substrate may expose the micro-drivers 404 to ambient light, which may pass between micro-LEDs and be incident on the micro-drivers 404 below. Exposure to ambient light may cause light interference with various components of the chiplet micro-drivers 404, which may affect their conductivity and disrupt their operation.

Touch sensor panel 400 may further comprise a photodetector 408. The photodetector 408 is configured to detect ambient light. In some examples, photodetectors 408 can include photodiodes disposed in the touch and display circuit layer 308 (e.g., FIG. 3A) or display pixel layer 318 (e.g., FIG. 3B) of the stack up. In some examples, photodetector 408 can include one or more micro-LEDs. Photodetectors 408 may be coupled to light sensing circuitry configured to measure ambient light incident on the photodetectors 408 as part of an ambient light sensor. In some examples, the light sensing circuitry for photodetectors 408 may be located in chiplets 404 along with micro-driver circuitry configured to drive micro-LEDs 402 and/or sense touch at touch electrodes of the touch sensor panel. In some examples, the light sensing circuitry for photodetectors 408 may be located in chiplets other than or different from the chiplet micro-drivers 404 (not shown). It is understood that the size of the photodetector 408 relative to the size of micro-LEDs 402 as depicted in the figures (e.g., FIGS. 4A and 4B) is merely illustrative and non-limiting, and that photodetectors 408 can be smaller or larger than depicted.

As mentioned above, the region of the touch sensor panel 400 corresponding to the location the photodetector 408 is referred to herein as photodetector region 410 of the touch sensor panel 400. Photodetector region 410 as illustrated has a rectangular shape. In some examples, the photodetector region 410 may have others shapes such as a square shape, a polygonal shape, a circular shape, an oval shape, or an irregular shape delimited by various combinations or lines and curves. The touch sensor panel 400 may include or more such photodetector regions 410 corresponding to one or more photodetectors 408 distributed across the panel.

Touch sensor panel 400 may further include an opaque layer, often referred to as a black matrix 414. Black matrix 414 is a layer of opaque material disposed at least partially in a layer above the micro-LEDs 402 within the stack up of the touch sensor panel 400 and extending across the panel. Black matrix 414 is configured to block visibility and/or shield components of the touch sensor panel 400 located below or opposite the black matrix from ambient light, while enabling light transmission (e.g., for display and/or optical sensing) through openings in the black matrix 414 at specific locations of the touch sensor panel 400. Black matrix 414 can thus include a plurality of opening arranged across the touch sensor panel 400 to enable visibility of the display pixels and the passage of light between the exterior of the touch sensor panel 400 and components of the touch sensor panel beneath the black matrix 414. In particular, a set of openings 418 is provided in the black matrix 414 at location corresponding to micro-LEDs 402 (e.g., each opening 418 is disposed above and/or opposite a micro-LED 402) to permit light emitted by the micro-LEDs 402 to pass through the matrix. As a result, openings 418 may be arranged across the black matrix 414 according to the pattern of micro-LEDs 402 across the touch sensor panel 400. In addition, another set of openings 420 may be provided in the black matrix 414 to enable ambient light to pass through the black matrix 414 to reach the photodetectors 408 or the ambient light sensor. Openings 420 in the black matrix 414 can be provided (in numbers and/or sizes sufficient) to enable a threshold amount of light to reach the photodetectors 408 (e.g., enough light to enable ambient light sensing). Additionally or alternatively, the density of openings 420 in the black matrix 414 in the photodetector region 410 can be high enough to enable a threshold amount of light for the photodetectors 408 or ambient light sensor.

In some examples, such as illustrated in FIGS. 4A and 4B, openings 420 can be arranged across the photodetector region 410 in a repeating pattern. In some examples, the openings 420 can be arranged across the photodetector region 410 in rows and columns. In some examples, openings 420 can be arranged in a repeating pattern along one axis across the photodetector region 410 (e.g., repeating along the rows or regular along the columns). In some examples, a repeating pattern of openings 420 in the photodetector region 410 can include a repeating pitch distance (e.g., measured center-to-center, or edge-to-edge) between the openings 420 along one or more axes across the photodetector region 410. In some examples, the repeating pattern can be a uniform pitch distance between the openings 420 along one or more axis. However, in some examples, the repeating pattern can include non-uniform pitch distances (e.g., pitch distances can vary along one or more axes according to a repeating pattern). In some examples, openings 420 can be arranged across the photodetector region 410 in patterns other than rows and columns. In some examples, openings 420 can be spread across the photodetector region 410 in a random manner (e.g., without a pattern).

As described herein, openings 418 are provided in both the photodetector region 410 and micro-driver region 412 to enable light output for the micro-LEDs. Openings 420 are provided in the photodetector region 410 to enable light to be detected by the photodetectors 408. In some examples, openings can also be provided in the micro-driver region 412 of the touch sensor panel 400 to improve optical characteristics of the touch sensor panel (e.g., reduce optical artifacts). For example, as illustrated in FIGS. 4A and 4B, openings 420 are distributed across both photodetector regions 410 as photodetector-region openings 422 and in the micro-driver regions 412 as micro-driver-region openings 424.

Openings 420 are shown in FIGS. 4A and 4B as having a rectangular shape. In the example illustrated, an opening 420 may have a width between 0.5 μm and 4 μm, and a length between 0.5 μm and 4 μm. It is understood that openings 420 can have a variety of shapes and dimensions. In some examples, the shape of openings 420 may be rectangular square, circular, oval, or any other shape suitable for enabling ambient light to reach photodetector 408. In some examples, the shape and dimensions of the openings 420 are the same within the photodetector regions 410 and the micro-driver regions 412.

The plurality of opening 420 can extend beyond the photodetector regions 410 and across the touch sensor panel 400 including the micro-driver regions 412 to provide optical uniformity and to reduce or prevent optical artifacts. Optical artifacts can be generated by regional variations in the shape, dimensions, or density of distribution of openings across the touch sensor panel 400. In some examples, artifacts can be generated when variations in the distance between openings 420 are large enough to be perceivable by a viewer. Accordingly, in some examples, openings 420 are provided in the black matrix 414 according to a uniform pattern. A uniform pattern of openings 420 (including micro-driver region openings 424 and photodetector-region openings 422) across the touch sensor panel (or across an axis of the touch sensor panel) can be further desirable to facilitate the manufacturing of the black matrix 414. Uniformity of openings patterns can simplify the manufacturing process of the black matrix 414 and reduce manufacturing cost. Accordingly, in some examples, the plurality of openings 420 can be arranged across the entire touch sensor panel according to uniform pattern across both the photodetector regions 410 and the micro-driver regions 412 (e.g., rows and columns of opening 420 traverse boundaries between photodetector regions 410 and micro-driver regions 412 while maintaining the pattern. For example, the pitch distance between openings 420 is the same along the rows of openings and/or along the columns of openings. Thus, in some examples, the plurality of openings 420 can exhibit the same pattern both within and outside of the photodetector regions 410.

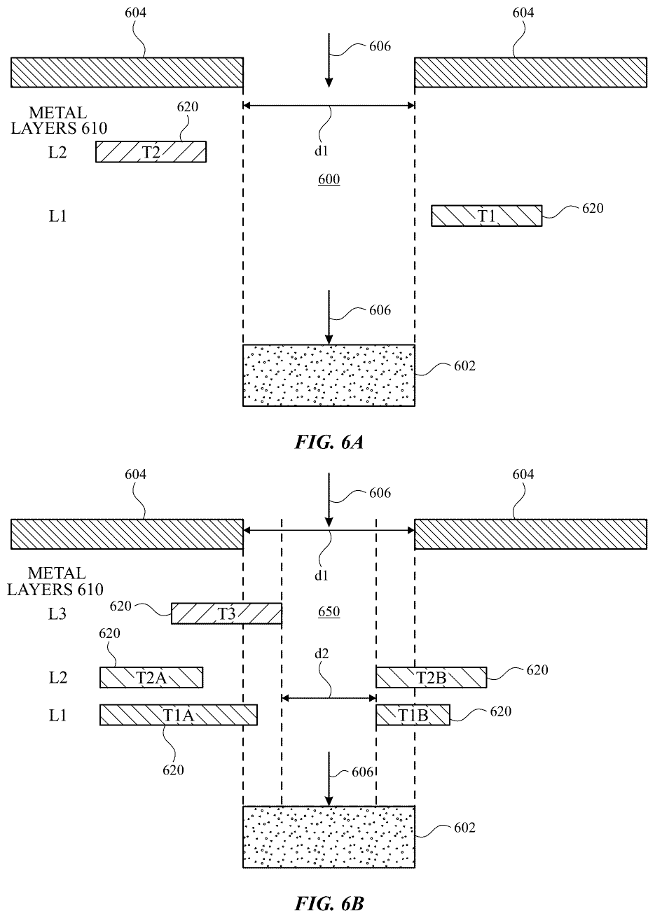

Although the description of FIGS. 4A-4B focuses on openings in an opaque layer, it is understood that a stack up can include a plurality of layers between the opaque layer and the micro-driver and/or a plurality of layers between the opaque layer and the photodetectors. FIG. 5 illustrates a representation of an example stack-up of metal layers 500 of the touch sensor panel 400 according to an example of the disclosure. The metal layers 500 are metal conductor traces etched, deposited, or otherwise disposed into one or more layers, at least partially separated by insulated material, to provide electrical connections between components of a device including the touch sensor panel 400. As such, a routing trace may be a portion of a metal layer 500 configured to route signals between the components. Touch sensor panel 400 may include a plurality of metal layers 500 disposed between the black matrix 414 and chiplet micro-drivers 404 and/or photodetectors 408. The plurality of metal layers 500 can include panel metal layers 510 which are configured to provide or establish electrical connections (e.g., portions of the metal layers 500 that form panel routing traces) between components of the touch sensor panel 400 such as for example, micro-LEDs 402, micro-drivers 404, touch and display controllers, etc. In the example illustrated, panel metal layers 510 include five metal layers P1, P2, P3, P4, and P5. Metal layers P1-P5 are ordered within the stack-up, with P5 representing an uppermost of the metal layers closer to black matrix 414 than P1. The number of panel metal layers 510 in FIG. 5 is merely illustrative, and the touch sensor panel 400 can include a different number of panel metal layers 510 (e.g., 2, 3, 5, 8, 10 panel metal layers). Panel metal layers 510 may further have a variety of dimensions, such as pitch distance (e.g., the distance between the center of a metal layer and the center of an adjacent metal layer) and layer thickness. For example, pitch distance between panel metal layers may range between 2.5 μm and 3.0 μm in some examples, and thickness may range between 0.4 μm and 0.8 μm. It should be understood that the dimensions provided for panel metal layers 510 are merely illustrative and that pitch distance, trace thickness, and other dimensions can differ from those described herein.

In the micro-driver region 412, the plurality of metal layers 500 can also include micro-driver metal layers 520, which are provided to route signals between micro-driver components and/or between micro-drivers 404 and micro-LEDs 402 (e.g., as portions of micro-driver metal layers that form micro-driver routing traces). One or more of the plurality of metal layers 500 can be routed to micro-driver pads (e.g., to which micro-drivers can be mounted during assembly). In the example illustrated, the micro-driver metal layers 520 includes layers M1, M2, M3, M4, M5, and M6. Micro-driver metal layers M1-P6 are ordered within the stack-up, with M6 representing an uppermost of the metal layers closer to black matrix 414 than M1. As with the panel metal layers 510, pitch distances between micro-driver metal layers 520 (e.g., between M2 and M3) can range between 2.5 μm and 3.0 μm, and a thickness of micro-driver metal layers 520 can range between 0.4 μm and 0.8 μm. In some examples, the lowest panel metal layer (e.g., P1) and the top surface of the highest micro-driver metal layer (e.g., M6) can be top-surface aligned (e.g., the top surfaces of both layers may be co-planar or the material in M6 and P1 may be disposed at least partially in the same layer).

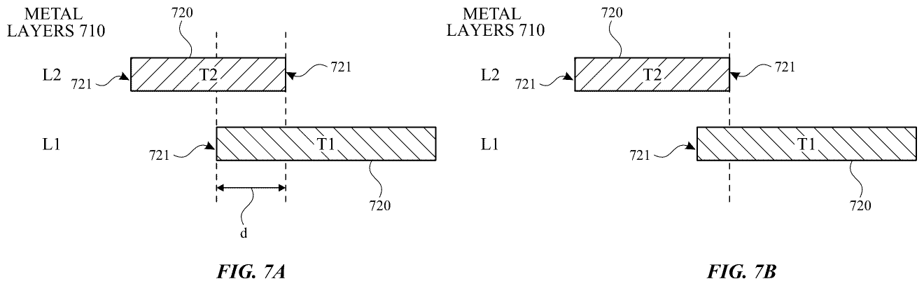

To enable optical sensing (e.g., ambient light sensing) using a photodetector disposed in the stack-up in a layer beneath the one or more panel metal layers and/or the one or more micro-driver metal layers, the stack-up must include a plurality of openings in the aforementioned layers in addition to the opening in the black matrix. FIGS. 6A and 6B illustrates example cross-sections of the stack-up of portions of the touch sensor panel having an opening in the photodetector region 410 according to examples of the disclosure. The stack-up includes a layer of black matrix 604 (e.g., corresponding to black matrix 414) and a photodetector 602 (e.g., corresponding to photodetector 408). A plurality of metal layers (e.g., corresponding to panel metal layers 510 or micro-driver metal layers 520 in FIG. 5) are disposed between the layer of black matrix 604 and the photodetector 602.

In FIG. 6A, the opening 600 corresponds to an opening 420 as described in reference to FIGS. 4A and 4B, and in particular to a photodetector-region opening 422 as previously described. Opening 600 has an area, represented in the cross-section of FIG. 6A by a distance d1 between the two segments of the black matrix. Opening 600 (e.g., the photodetector-region opening) is provided in the black matrix 604 to enable incident light 606 to reach photodetector 602, which is disposed at the bottom of the stack up. The touch sensor panel of FIG. 6A further includes two metal layers 610 (e.g., L1 and L2). Representative, and non-limiting, routing traces 620 (e.g., T1 and T2) are illustrated in the two metal layers. In particular, routing trace T1 is formed in or represents a portion of metal layer L1, and routing trace T2 is formed in or represents portion of metal layer L2. In some examples, the routing traces T1 and T2 are panel routing traces (e.g., portions of the set of metal layers P1-P5 illustrated in FIG. 5).

To enable passage of incident light from opening 600 to photodetector 602, additional openings are included in the one or more metal layers 610. Specifically, in some examples, the additional openings in the one or more metal layers 610 opposite the opening 600 in the black matrix have an area that is greater than the area of opening 600. For example, as shown in the cross-section of FIG. 6A, none of the traces in layers L1 and L2 are disposed between the dashed lines representing the boundaries of opening 600. For example, routing traces 620 (e.g., T1 and T2) do not extend opposite (e.g., below) opening 600. As a result, the pathway (e.g., a shaft) from opening 600 to photodetector 602 is free from optical obstruction by the one or more metal layers. Thus, the pathway free from optical obstruction enables at least a threshold amount of light (e.g., a maximum) amount of light to be incident on photodetector 602. The openings in metal layers and black matrix, including opening 600, thus enables and/or improves transmittivity of ambient light to the photodetector 602, in some examples.

In some examples, the additional openings in the one or more metal layers 610 opposite the opening 600 in the black matrix have an area that is greater than the area of opening 600. In some examples, the additional openings in the one or more metal layers 610 opposite the opening 600 in the black matrix have a dimension (e.g., cross-sectional distance between segments in a respective layer) that is greater than a dimension (e.g., cross-sectional distance between segments of the black matrix) of opening 600.

In some examples, the additional openings in the one or more metal layers 610 can be different than shown in FIG. 6A, and include one or more metal traces at least partially obstructing the pathway from the opening in the black matrix to the photodetector 602. In FIG. 6B, the opening 650 corresponds an opening 600 as described in reference to FIG. 6A. The touch sensor panel further includes multiple metal layers 610 (e.g., L1, L2, and L3) disposed between the layer of black matrix 604 and photodetector 602. Portions of the metal in the multiple metal layers 610 are disposed opposite opening 650 in the black matrix 604 in the pathway between opening 650 and photodetector 602. For example, routing traces 620 (e.g., T1A, T1B, T2B, and T3) are at least partially formed in the optical pathway. In particular, routing traces T1A and T1B are formed in or represents portions of metal layer L1, routing traces T2A and T2B are formed in or represents portions of metal layer L2, and routing trace T3 is formed in or represents a portion of metal layer L3. Unlike in FIG. 6A, routing traces 620 (e.g., T1A, T1B, T2B, and T3) are routed at least in part through the pathway between opening 650 and photodetector 602. The routing traces 620 (e.g., T1A, T1B, T2A, T2B, and T3) can be panel routing traces (e.g., portions of the set of metal layers P1-P5 illustrated in FIG. 5 and previously described) and/or micro-driver routing traces. Although the intrusion of the routing traces 620 (e.g., T1A, T1B, T2B, and T3) narrow the pathway for ambient light path to traverse to the photodetector 602 compared to opening 650 in the black matrix 604, the routing traces 620 (e.g., T1A, T1B, T2B, and T3) may still enable incident light 606 to reach the photodetector 602. Depending on the arrangement of routing traces (e.g., opening sizes, overlapping of traces, reflective characteristics, the amount of incident light may decrease (or in some cases not decrease). For example, FIG. 6B shows an obstruction free opening for the pathway with a distance d2 in the cross-section that is less than the distance d1 of opening 650. The portion of the opening in each of the metal layers 610 opposed opening 650 shown in FIG. 6B is less than d1, but greater than d2. The amount of incident light may also be dependent on the characteristics of the incident light. For example, the ambient light reaching the photodetector 602 may be direct light (e.g., light that can reach the surface of photodetector 602 without being obstructed by a trace, reflected light (e.g., ambient light reflected between components of stack up within the opening 420, such as light that may bounce between routing traces 620, and/or diffracted light (e.g., light that is bent around the edges of the routing traces 620, edges of the opening 600 and other components of the stack up). Although routing traces 620 traverse the pathway between opening 650 and photodetector 602 below, the metal layer density (e.g., as reflected by the number and position of routing traces disposed opposite opening 650) is designed in an example like FIG. 6B to be sufficiently low to enable a threshold amount of incident light 606 to reach photodetector 602. It is understood that FIG. 6B is a cross-sectional view of the pathway to photodetector 602 including opening 650, and that routing traces 620 (e.g., T1A, T1B, T2A, T2B, and T3) and their number, dimensions, and spatial arrangements are illustrative and non-limiting. As such, cross-sections at different depths relative to the one illustrated in FIG. 6B can have different openings in the one or more metal layers 610 than shown in FIG. 6B. For example, at some cross-sections there can be a different number of routing traces having different spatial arrangement than in FIG. 6B, some of which may or may not be at least partially obstructing of the pathway from the opening in the black matrix to the photodetector 602. Taken together, such openings with different arrangements for routing traces also provide a pathway from the black matrix to the photodetector to enable a threshold amount of light to be incident on the photodetector.

Referring back to FIGS. 4A and 4B, while openings 420 are provided in the photodetector region 410 to enable light to reach the photodetectors 408 and/or ambient light sensor, light passing through the openings 420 in the micro-driver region 412 (e.g., micro-driver-region openings 424) can adversely interfere with the functioning of micro-driver circuitry, in some examples. Additionally, including openings 420 in the micro-driver region 412 can improve optical performance. Accordingly, examples of the present disclosure provide techniques for mitigating the interference of ambient light with the micro-driver circuitry by including openings 420 in the micro-driver region 412 in the layer of black matrix, but reducing the amount of incident light or eliminating incident light on micro-driver 404 by engineering openings in the one or more metal layers below the layer of black matrix. For example, customizing the geometry (e.g., the spatial arrangement or relative positioning) of routing metals between the micro-driver-region openings 424 and micro-driver circuitry can be used to attenuate and/or block ambient light from reaching the micro-driver circuitry. In some examples, the spatial arrangement of panel routing traces between the micro-driver-region openings 424 and micro-driver circuitry can be leveraged to attenuate and/or block the ambient light incident on the touch sensor panel 400 from the micro-driver circuitry (e.g., the chiplet silicon) within the touch sensor panel. In some examples, the spatial arrangement of micro-driver routing traces between the micro-driver-region openings 424 and micro-driver circuitry can be used to attenuate and/or block the ambient light. In some examples, the spatial arrangement of both panel routing traces and micro-driver routing traces between the micro-driver-region openings 424 and micro-driver circuitry can be used to attenuate and/or block ambient light from sensitive circuits. Further, as will be described below, the geometry of the routing traces and in particular, their positioning relative to each other between the micro-driver-region openings 424 and micro-driver circuitry, can be optimized reduce the amount of incident light (e.g., to maximize the obstruction of the incident light). In some examples, the geometry of the routing traces can be configured to completely block direct light transmission, and also mitigate or block transmission to circuitry of light diffusing through layers of the touch sensor panel.

FIG. 7A and 7B illustrate examples of spatial arrangements of portions of metal layers forming routing traces, according to examples of the disclosure. FIG. 7A illustrates an example of an overlap between two routing traces 720 (T1 and T2) in two different corresponding metal layers 710 (e.g., as portions of metal layers L1 and L2, respectively). In some examples, metal layers L1 and L2 can be adjacent layers (e.g., no conductive layers are disposed between layers L1 and L2) or non-adjacent layers separated by one or more conductive layers including one or more metal layers. In some examples, the metal layers L1 and L2 can both be panel metal layers, micro-driver metal layers, or metal layer L1 can be a panel metal layer and metal layer L2 can be a micro-driver metal layer. In some examples, a routing trace 720 (e.g., L1, L2) features opposing edges 721, such as left and right edges in the orientation of FIGS. 7A-7B, book-ending the width of the routing trace 720 as shown. In FIG. 7A, routing trace T2 is shown as overlapping routing trace T1. In particular, routing trace T2 is overlapping routing trace T1 by a distance or amount d showing in FIG. 7A between the right edge of routing trace T2 and the left edge of routing trace T1. It is understood that the overlap between routing traces T1-T2 can be described alternatively as routing trace T2 is overlapping a first edge of routing trace T1 by a distance or amount d, routing trace T1 is overlapping a first edge 721 of routing trace T2 by a distance or amount d, and/or routing trace T1 and routing trace T2 are overlapping (and/or overlapping each other) by a distance or amount d. An overlap between routing traces (e.g., T1, T2) is among the spatial arrangements between routing traces 720 that are configured to attenuate or block light entering openings micro-driver region openings 424. In some examples, and will be explained further below, such spatial arrangement can include the distance d of overlap between two traces that is configured to minimize the passage of light.

FIG. 7B illustrates an example of an alignment of a respective edge between two routing traces 720 (T1 and T2) in two different corresponding metal layers 710 (L1 and L2). In some examples, metal layers L1 and L2 can be adjacent layers (e.g., no conductive layers are disposed between them) or non-adjacent layers separated by one or more conductive layers including one or more metal layers. In some examples, the metal layers L1 and L2 can both be panel metal layers, micro-driver metal layers, or metal layer L1 can be a panel metal layer and metal layer L2 can be a micro-driver metal layer, or metal layer L1 can be a micro-driver metal layer and metal layer L2 can be a panel metal layer. In some examples, a routing trace 720 (e.g., L1, L2) features opposing edges 721, such as left and right edges in the orientation of FIGS. 7A-7B, book-ending the width of the routing trace 720 as shown. An edge 721 (left edge) of routing trace T1 is aligned with an edge 721 (right edge) of routing trace T2. In other words, the respective edge of each routing trace abuts against the same orthogonal line (e.g., the dashed vertical light shown in FIG. 7B). An alignment between routing traces (e.g., T1, T2) is among the spatial arrangements between routing traces 720 that are configured to block light entering openings micro-driver region openings 424. It is understood that different levels of overlap can impact the passage of light passing through the metal layers 710. For example, the overlapping routing traces shown in FIG. 7A can block relatively more light than the alignment of edges shown in FIG. 7B.

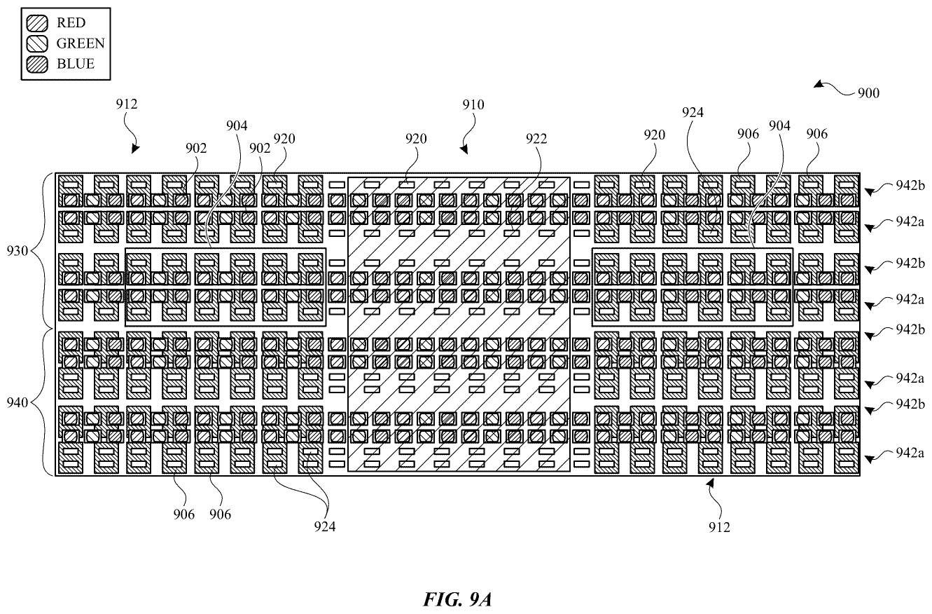

As described herein, it is desired to attenuate or block light from reaching sensitive circuitry in the micro-driver region 412. Accordingly, as will be described below, the geometry of the routing traces and in particular, their relative arrangement between the micro-driver-region openings 424 and micro-driver circuitry, can be designed to increase the obstruction of incident light (e.g., optimize to maximize the obstruction of the incident light). In some examples, the geometry and arrangement of the routing traces can be configured to completely block direct light transmission, and also mitigate or block transmission to circuitry of light diffusing through layers of the touch sensor panel. FIG. 8 illustrates an example cross-section of an opening 800 in the micro-driver region according to an example of the disclosure. In particular, the figure illustrates a pathway (e.g., a shaft) from opening 800 to a micro-driver 802 corresponding to micro-driver-region opening 800 disposed opposite a micro-driver 802 of micro-driver region 412. It is desired to block incident ambient light from reaching the micro-driver circuitry.

Opening 800 corresponds to an opening 420 as described in reference to FIGS. 4A and 4B, and in particular to a micro-driver-region opening 424 as previously described in reference to the same figures. The touch sensor panel includes five metal layers 810 (e.g., L1, L2, L3, L4, and L5) disposed between the black matrix 804 and micro-driver 802, portions of which are disposed opposite opening 800 in the black matrix 804 (e.g., between segments of black matrix 804A and 804B) as routing traces 820 (e.g., T1A, T1B, T2, T4, T4A and T5B). In particular; routing traces T1A and T1B are formed in or represent a portion of metal layer L1; routing trace T2 is formed in or represents a portion of metal layer L2; routing traces T3A and T3B are formed in or represent a portion of metal layer L3; routing trace T4 is formed in or represents a portion of metal layer L4, and routing traces T5A and T5B are formed in or represent a portion of metal layer L5. The metal layers 810 and corresponding routing traces 820 illustrated are merely exemplary and any number of metal layers and routing traces 820 can be provided in the touch sensor panel in association with illustrated opening 800.

In some examples, portions of routing traces 820 in or more layers may extend at least partially into the pathway opposite opening 800 in order to block ambient light 806 from reaching the silicon surface. For example, routing metals T1A, T1B, T2, T4, T5A, and T5B are shown disposed at least partially within the pathway opposite (e.g., below) opening 800. However, since the portions of the routing traces 820 within the pathway are narrower than the width of the opening 800, which enables, for a respective layer, some light to pass through gaps between the portions of the routing traces and the pathway boundary 815 corresponding to opening 800 (e.g., a vertical line from an edge 805 of the opening 800 in the black matrix defining a boundary of the opening in the stack up). The relative position of the routing traces 820 across multiple layers, however, can be designed (e.g., optimized) to block the passage of light 806 in the pathway to reduce light incident on micro-driver 802. In particular, as shown in FIG. 8, the routing traces 820 within the pathway can be staggered or positioned to align and/or overlap with one another to block light 806 from reaching the silicon surface of micro-driver 802.

For example, as shown in FIG. 8, routing traces T5A and T5B of metal layer L5 both extend into the pathway over edges 805 of opening 800 (segments of black matrix 804A and 804B), leaving a gap 821 in the pathway between their respective edges that is narrower than opening 800. Routing trace T4 of metal layer L4 is provided to block at least some of the light incident through gap 821. In particular, a first edge (right edge) of routing trace T5A is aligned with a first edge (left edge) of routing trace T4, whereas a first edge of routing metal T5B (left edge) is aligned with a second edge (right edge) of routing trace T4 that is opposite of the first edge. The configuration of the routing traces in layers L4 and L5 reduces the amount of incident ambient light 806 that is able to reach below metal layers L5 and L4. It is understood that routing trace T4 is disposed to block gap 821 between routing traces T5A and T5B, or that equivalently, routing traces T5A and T5B are disposed to block gaps 823 on either side of routing trace T4. In some examples, the distance or amount of extension of routing trace T5A into the pathway over edge 805 of opening 800 (e.g., over the segment of black matrix 804A) may be a predetermined distance 831 or amount of extension configured to optimize the attenuation or obstruction of light. Similarly, the distance 833 or amount of extension of routing trace T5B into the pathway over edge 805 of opening 800 (e.g., over the portion of black matrix 804B) may be a predetermined distance or amount of extension configured to optimize the attenuation or blocking of light. In the example illustrated, routing traces T5A and T5B extend into the pathway of opening 800 by the same amount or distance (e.g., distances 831 and 833).

Additional routing traces are disposed below routing trace T4 to further block at least some of the incident light 806 from reaching micro-driver 802. For example, routing trace T3A of metal layer L3 is provided below metal layer L4 and has a first edge (right edge) aligned with a first edge 805 of the opening 800, and routing trace T3B of the same metal layer L3 is provided on the opposite side of the opening 800, and also has a first edge (left edge) aligned with a first edge 805 of the opening 800, leaving a gap 825 between routing traces T3A and T3B having the width of opening 800. Routing trace T2 of metal layer L2 below metal layer L3 blocks most of the gap 825, having a first edge (left edge of T2) aligned with the first edge (right edge) of routing trace T5A of metal layer L5. The second edge (right edge) of routing trace T2 is aligned with the first edge (left edge) of routing trace T3B of metal layer L3, but also overlaps the first edge (left edge) of routing trace T5B of metal layer L5. In some examples, the distance 833 or amount of overlap of the second edge (right edge) of routing trace T2 with the first edge (left edge) of routing trace T5B may be a predetermined distance or amount of overlap configured to optimize the attenuation or blocking of light. As previously described, routing trace T4 is disposed in the pathway of opening 800 such that it leaves a gap 823 on each side between the respective edge of T4 on each side and the respective pathway boundary 815 corresponding to opening 800. In contrast, routing trace T2 abuts or is aligned with the boundary on the right side (e.g., the second or right edge of the routing trace T2) to close the gap and block the passage of light on the right side, while leaving a gap 827 that may enable light to pass on the left side. In metal layer L1, disposed below metal layer L2, routing metal T1A overlaps the first edge (left edge) of routing trace T2. In some examples, the distance 835 or amount of overlap of the routing trace T1A with the first edge (left edge) of routing trace T2 may be a predetermined distance or amount of overlap configured to optimize the attenuation or blocking of light. Further, routing metal T1B overlaps the second edge (right edge) of routing trace T2. In some examples, the distance 837 or amount of overlap of routing trace T1B with the second edge (right edge) of routing trace T4 may be a predetermined distance or amount of overlap configured to optimize the attenuation or blocking of light. Further, routing traces T1A and T1B extend into the pathway of opening 800 by different amounts to leave a central gap 829 in the pathway. As shown, routing trace T1A extends into the pathway (e.g., past edge 805 of the opening 800) by a distance 839 or amount of extension greater than the distance 837 or amount of extension of routing trace T1B into the pathway. This configuration differs from that of routing traces T5A and T5B which also leave a central gap 821 in the pathway but extend into the pathway by same distance or amount, as previously described.

The relative positions of routing traces T1A, T1B, T2, T3A, T3B, T4, T5A, and T5B and in particular their alignments and/or overlaps with one another as well as the amounts and/or distances of the overlaps (e.g., distances 831, 833, 835, 837, and 839), combine to minimize or block the passage of ambient light 806 through the micro-driver-region opening 800 and shield the micro-driver 802 and other touch panel circuitry below from ambient light interference. It should be noted that the spatial arrangement of routing traces 820 as shown in FIG. 8 is merely illustrative, and various combination of number and geometry (e.g., relative positioning or spatial arrangement including distances or amounts of overlap and/or extension into the shaft of opening 800) of routing traces 820 can be formed to block light incident onto micro-driver circuitry.

In some examples, the geometry or spatial arrangement of the routing traces and in particular the alignment and/or overlap between routing traces 820 of a metal layer 810 and routing traces 820 of one or more adjacent layers 810 can be calculated or optimized to minimize or block direct light, which is light that can reach the silicon surface without interacting with another component were the routing traces not disposed inside the pathway of the micro-driver-region opening 424 (as illustrated in FIG. 8 as opening 800). The geometry or spatial arrangement between the routing traces 820 can further minimize or block reflected light, which is ambient light that may reflect or bounce against or between components of the stack up inside the pathway of the opening 800, such as light that may be reflected between the routing traces 820. In some examples, the geometry or spatial arrangement between routing traces 820 can minimize or block diffracted light, which is light that is bent around the edges of the layers, the opening and other components of the stack up inside the pathway. In some examples, the geometry or spatial arrangement between routing traces 820 can minimize or block direct light, reflected light, and diffracted light.

In some examples, a distance of overlap between routing traces 820 and/or a distance of extension of a routing trace 820 past another or into the pathway of opening 800 is configured to optimize the blocking of light between the opening 800 and the sensitive circuitry between which the routing traces 820 are disposed. For example, the amount of extension of routing trace T5A into the pathway of opening 800 may be calculated to be a predetermined amount that, in combination with other dimensions such as various amounts of overlaps between routing traces 820 and/or extension of routing traces into the pathway, ensure optimal attenuation or blocking of light through opening 800. Similarly, the distance or amount of extension of routing trace T5B into the pathway may be configured to optimize ambient light attenuation or blocking, in some examples. In some examples, the distance or amount of extension of routing trace T5A from routing trace T3A may be configured to optimize ambient light attenuation or blocking. Similarly, in some examples, the distance or amount of extension of routing trace T5B from routing trace T3B may be configured to optimize ambient light attenuation or blocking. In some examples, the distance or amount of overlap between a first edge (left edge) of routing trace T2 and routing trace T1A may be configured to optimize ambient light attenuation or blocking. In some examples, the distance or amount of overlap between a second edge (right edge) of routing trace T2 and routing trace T1B may be configured to optimize ambient light attenuation or blocking.

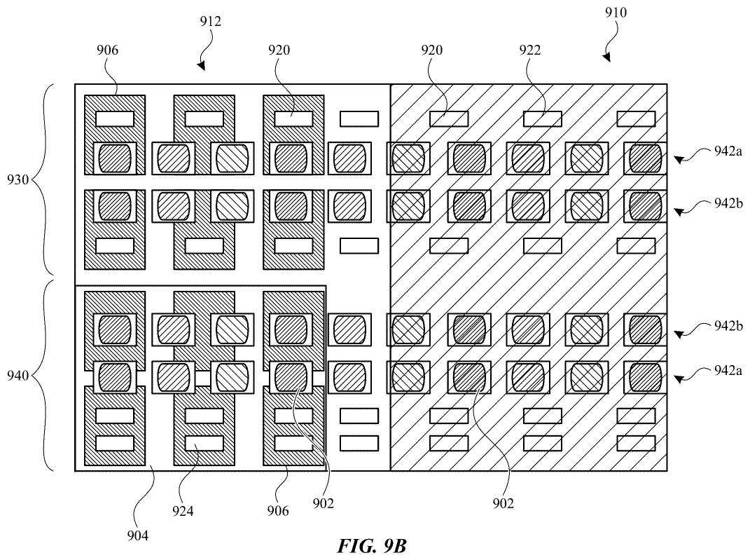

FIGS. 9A and 9B illustrate portions of a touch sensor panel 900 according to an example of the disclosure. The touch sensor panel 900 is substantially similar to touch sensor panel 400, previously described. As such, the touch sensor panel 900 includes a plurality of micro-LEDs 902 arrayed in rows and columns of display pixels across the touch sensor panel 900, one or more micro-drivers 904 configured to drive the micro-LEDs 902, and a plurality of micro-driver pads 906 arranged in rows and columns (e.g., along a first axis and a second axis). The touch sensor panel 900 also includes a black matrix of opaque material including a plurality of openings 920 adjacent to the micro-LEDs 902 and also arrayed in rows and columns. The spatial arrangement of micro-LEDs 902 and openings 920 for the region 930 of touch sensor panel 900 can be similar that of touch sensor panel 400 of FIGS. 4A and 4B. In particular, in region 930, micro-driver-region openings 924 are disposed one-to-one pattern upon the micro-drivers pads 906 arranged in rows and columns across the touch sensor panel 900 (e.g., each micro-driver pad 906 corresponds to an opening 924). However, region 940 of the panel exhibits a different pattern of openings 920, in some examples. In particular, rows 942a of micro-drivers pads 906 with each micro-driver pad 906 having two openings 920 disposed opposite of the micro-driver pad 906 alternate with rows 942b of micro-driver pads 906 without openings. In the examples illustrated in FIGS. 9A and 9B, a column of micro-driver pads 906 can include a micro-driver pad 906 having no openings, a micro-driver pad 906 having an opening, and/or a micro-driver pad 906 having two openings (e.g., a first micro-driver pad 906 of the column (e.g., a first axis) can include a first number of the plurality of openings 920 and a second micro-driver pad 906 of the column can include a second number of the plurality of openings 920, different from the first number of the plurality of openings 920). It is understood that the number of openings disposed on or opposite a micro-driver pad 906 is non-limiting and that a micro-driver pad 906 can include more than two openings.

The configuration of micro-driver pads 906 and openings 920 in the region 940 of the touch sensor panel 900 compared with region 930 is due to a difference between the pitch distance (e.g., measured center-to-center, or edge-to-edge) of the array of micro-LEDs 902 and the array of corresponding micro-drivers pads 906, in some examples. In particular, the pitch distance between micro-driver pads 906 can be slightly greater than a pitch distance between micro-LEDs 902, in some examples. The resulting mismatch between the location of micro-drivers pads 906 and micro-LEDs 902 reduces available space corresponding to micro-drivers pads 906 of rows 942b while increasing space corresponding to micro-drivers pads 906 of rows 942b. Since within the micro-driver region 912, micro-driver metal layers may be required to provide the overlapping routing traces necessary to block ambient light from reaching the micro-driver circuitry, openings 920 normally disposed on rows are shifted to the micro-drivers pads 906 of rows 942a that are able to accommodate two openings 920. Accordingly, in some examples, the plurality of openings 920 is arranged in a uniform pattern along a row of openings and in a non-uniform pattern along a column of openings 920.

The variation in the pattern of openings between region 930 of the touch sensor panel 900 and region 940 is provided to compensate for mismatches in openings patterns and micro-driver pad patterns due to differing micro-LED 902 and micro-driver pad 906 pitch distances. While in contrast to the micro-driver region 912 of the touch sensor panel, openings 920 in the photodetector region 910 are free of micro-driver pads 906, the locations of the openings 920 (e.g., photodetector-region openings 922) are restricted by the pattern of openings 920 in the micro-driver region (e.g., micro-driver-region openings 924) to maintain a uniformity of openings 920 across the touch sensor panel 900 to prevent display artifacts and reduce manufacturing complexity and cost. Accordingly, the array of openings 920 extends into the photodetector region 910 according to the same pattern as in the micro-driver region 912, including openings 920 that are doubled up on alternate rows 942a of micro-driver pads 906 of the touch sensor panel 900. The openings pattern across the touch sensor panel 900 including in the photodetector region 910 may thus be determined by the pattern of micro-driver pads 906, in some examples.

Therefore, according to the above, some examples of the disclosure are directed to a touch sensor panel. The touch sensor panel can include a micro-driver region corresponding to a chiplet micro-driver and a photodetector region corresponding to a photodetector; a first layer of opaque material in the micro-driver region and the photodetector region, the first layer of opaque material including a plurality of openings in the micro-driver region and the photodetector region including a first opening in the micro-driver region opposite the chiplet micro-driver and a second opening in the photodetector region opposite the photodetector; and a plurality of metal layers between the first layer of opaque material and the chiplet micro-driver and the photodetector. One or more first portions of one or more of the plurality of metal layers can be disposed opposite the first opening and be configured to at least partially block light entering the first opening from being incident on the chiplet micro-driver. Additionally or alternatively to one or more of the examples disclosed above, in some examples, each of the one or more first portions of the one or more of the plurality of metal layers opposite the first opening can have a dimension smaller than a dimension of the first opening. Additionally or alternatively to one or more of the examples disclosed above, in some examples, the one or more first portions of the one or more of the plurality of metal layers can include a first routing trace in a first metal layer and a second routing trace in a second metal layer, different from the first metal layer, the first routing trace overlapping the second routing trace by a first predetermined amount. Additionally or alternatively to one or more of the examples disclosed above, in some examples, the first routing trace can have a first edge and a second edge, opposite the first edge; the second routing trace can overlap the first edge of the first routing trace; the one or more first portions of the one or more of the plurality of metal layers can further include a third routing trace in a third metal layer, different from the first and the second metal layers; and the third routing trace can overlap the first routing trace at the second edge of the first routing trace by a second predetermined distance. Additionally or alternatively to one or more of the examples disclosed above, in some examples, the first routing trace can have a first edge and a second edge, opposite the first edge; the second routing trace can overlap the first edge of the first routing trace; the one or more first portions of the one or more of the plurality of metal layers can further include a third routing trace in the first metal layer; and the third routing trace can overlap the first routing trace within the first opening at the second edge of the first routing trace by a second predetermined distance. Additionally or alternatively to one or more of the examples disclosed above, in some examples, the one or more first portions of the one or more of the plurality of metal layers can include a first routing trace in a first metal layer a second routing trace in a second metal layer; the second metal layer can be adjacent to the first metal layer; and a first edge of the first routing trace can be aligned with a first edge of the second routing trace. Additionally or alternatively to one or more of the examples disclosed above, in some examples, the one or more first portions of the one or more of the plurality of metal layers can include a third routing trace in the first metal layer; and a first edge of the third routing trace can be aligned with a second edge of the second routing trace, opposite of the first edge of the second routing trace. Additionally or alternatively to one or more of the examples disclosed above, in some examples, the one or more first portions of the one or more of the plurality of metal layers can further include a fourth routing trace and a fifth routing trace in a third metal layer adjacent to the second metal layer; a first edge of the fourth routing trace can be aligned with a first edge of the first opening; a first edge of the fifth routing trace can be aligned with a second edge of the first opening, opposite the first edge of the first opening; and a distance between the first edge of the fourth routing trace and the first edge of the fifth routing trace can be equal to a distance between the first edge of the first opening and the second edge of the second opening. Additionally or alternatively to one or more of the examples disclosed above, in some examples, the one or more first portions of the one or more of the plurality of metal layers can further include a sixth routing trace in a fourth metal layer adjacent to the third metal layer; a first edge of the sixth routing trace can be aligned with the first edge of the third routing trace; a second edge of the sixth routing trace, opposite the first edge of the sixth routing trace, can be aligned with the second edge of the first opening; and the sixth routing trace can overlap the second edge of the third routing trace. Additionally or alternatively to one or more of the examples disclosed above, in some examples, the one or more first portions of the one or more of the plurality of metal layers can further include a seventh routing trace and an eighth routing trace in a fifth metal layer adjacent to the fourth metal layer; the seventh routing trace can overlap the first edge of the sixth routing trace; and the eighth routing trace can overlap the second edge of the sixth routing trace. Additionally or alternatively to one or more of the examples disclosed above, in some examples, a first metal layer of the one or more of the plurality of metal layers can be a micro-driver metal layer configured to route micro-driver signals and a second metal layer of the one or more of the plurality of metal layers can be a panel metal layer configured to route signals other than micro-driver signals. Additionally or alternatively to one or more of the examples disclosed above, in some examples, the plurality of openings can be arranged in a uniform pattern across the micro-driver region and the photodetector region. Additionally or alternatively to one or more of the examples disclosed above, in some examples, the plurality of openings can be arranged in rows and columns of openings across the micro-driver region and the photodetector region. Additionally or alternatively to one or more of the examples disclosed above, in some examples, the plurality of openings can include a plurality of first openings including the first opening; the chiplet micro-driver can include a plurality of pads in the micro-driver region including a first pad and a second pad arranged along a first axis; and the first pad can include a first number of the plurality of openings and a second pad can include a second number of the plurality of openings, different from the first number of the plurality of openings. Additionally or alternatively to one or more of the examples disclosed above, in some examples, the plurality of metal layers can include a plurality of openings opposite the second opening to enable the light entering the second opening to be incident on the photodetector. Additionally or alternatively to one or more of the examples disclosed above, in some examples, one or more second portions of the one or more of the plurality of metal layers can be disposed opposite the second opening and configured to enable a threshold amount of light entering the second opening to be incident on the photodetector.

Some examples of the disclosure are directed to an electronic device. The electronic device can include an energy storage device, communication circuitry, and a touch screen according to the examples described herein. For example, the touch screen can include a micro-driver region corresponding to a chiplet micro-driver and a photodetector region corresponding to a photodetector; a first layer of opaque material extending through the micro-driver region and the photodetector region, the first layer of opaque material including a plurality of openings in the micro-driver region and the photodetector region including a first opening in the micro-driver region opposite the chiplet micro-driver and a second opening in the photodetector region opposite the photodetector; and a plurality of metal layers between the first layer of opaque material and the chiplet micro-driver and the photodetector. One or more first portions of one or more of the plurality of metal layers can be disposed opposite the first opening and configured to at least partially block light entering the first opening from being incident on the chiplet micro-driver.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A touch sensor panel comprising:
a micro-driver region corresponding to a chiplet micro-driver and a photodetector region corresponding to a photodetector;
a first layer of opaque material in the micro-driver region and the photodetector region, the first layer of opaque material including a plurality of openings in the micro-driver region and the photodetector region including a first opening in the micro-driver region opposite the chiplet micro-driver and a second opening in the photodetector region opposite the photodetector; and
a plurality of metal layers between the first layer of opaque material and the chiplet micro-driver and the photodetector, wherein one or more first portions of one or more of the plurality of metal layers are disposed opposite the first opening and configured to at least partially block light entering the first opening from being incident on the chiplet micro-driver.

2. The touch sensor panel of claim 1, wherein each of the one or more first portions of the one or more of the plurality of metal layers opposite the first opening has a dimension smaller than a dimension of the first opening.

3. The touch sensor panel of claim 1, wherein the one or more first portions of the one or more of the plurality of metal layers include a first routing trace in a first metal layer and a second routing trace in a second metal layer, different from the first metal layer, the first routing trace overlapping the second routing trace by a first predetermined amount.

4. The touch sensor panel of claim 3, wherein:
the first routing trace has a first edge and a second edge, opposite the first edge;
the second routing trace overlaps the first edge of the first routing trace;
the one or more first portions of the one or more of the plurality of metal layers further include a third routing trace in a third metal layer, different from the first and the second metal layers; and
the third routing trace overlaps the first routing trace at the second edge of the first routing trace by a second predetermined distance.

5. The touch sensor panel of claim 3, wherein:
the first routing trace has a first edge and a second edge, opposite the first edge;
the second routing trace overlaps the first edge of the first routing trace;
the one or more first portions of the one or more of the plurality of metal layers further include a third routing trace in the first metal layer; and
the third routing trace overlaps the first routing trace within the first opening at the second edge of the first routing trace by a second predetermined distance.

6. The touch sensor panel of claim 1, wherein:
the one or more first portions of the one or more of the plurality of metal layers include a first routing trace in a first metal layer a second routing trace in a second metal layer;
the second metal layer is adjacent to the first metal layer; and
a first edge of the first routing trace is aligned with a first edge of the second routing trace.

7. The touch sensor panel of claim 6, wherein:
the one or more first portions of the one or more of the plurality of metal layers include a third routing trace in the first metal layer; and
a first edge of the third routing trace is aligned with a second edge of the second routing trace, opposite of the first edge of the second routing trace.

8. The touch sensor panel of claim 7, wherein:
the one or more first portions of the one or more of the plurality of metal layers further include a fourth routing trace and a fifth routing trace in a third metal layer adjacent to the second metal layer;
a first edge of the fourth routing trace is aligned with a first edge of the first opening;
a first edge of the fifth routing trace is aligned with a second edge of the first opening, opposite the first edge of the first opening; and
a distance between the first edge of the fourth routing trace and the first edge of the fifth routing trace is equal to a distance between the first edge of the first opening and the second edge of the second opening.

9. The touch sensor panel of claim 8, wherein:
the one or more first portions of the one or more of the plurality of metal layers further include a sixth routing trace in a fourth metal layer adjacent to the third metal layer;
a first edge of the sixth routing trace is aligned with the first edge of the third routing trace;
a second edge of the sixth routing trace, opposite the first edge of the sixth routing trace, is aligned with the second edge of the first opening; and
the sixth routing trace overlaps the second edge of the third routing trace.

10. The touch sensor panel of claim 9, wherein:
the one or more first portions of the one or more of the plurality of metal layers further include a seventh routing trace and an eighth routing trace in a fifth metal layer adjacent to the fourth metal layer;
the seventh routing trace overlaps the first edge of the sixth routing trace; and
the eighth routing trace overlaps the second edge of the sixth routing trace.

11. The touch sensor panel of claim 1, wherein a first metal layer of the one or more of the plurality of metal layers is a micro-driver metal layer configured to route micro-driver signals and a second metal layer of the one or more of the plurality of metal layers is a panel metal layer configured to route signals other than micro-driver signals.

12. The touch sensor panel of claim 1, wherein the plurality of openings is arranged in a uniform pattern across the micro-driver region and the photodetector region.

13. The touch sensor panel of claim 1, wherein the plurality of openings is arranged in rows and columns of openings across the micro-driver region and the photodetector region.

14. The touch sensor panel of claim 1, wherein:
the plurality of openings includes a plurality of first openings including the first opening;
the chiplet micro-driver includes a plurality of pads in the micro-driver region including a first pad and a second pad arranged along a first axis; and
the first pad includes a first number of the plurality of openings and a second pad includes a second number of the plurality of openings, different from the first number of the plurality of openings.

15. The touch sensor panel of claim 1, wherein the plurality of metal layers includes a plurality of openings opposite the second opening to enable the light entering the second opening to be incident on the photodetector.

16. The touch sensor panel of claim 1, wherein one or more second portions of the one or more of the plurality of metal layers are disposed opposite the second opening and configured to enable a threshold amount of light entering the second opening to be incident on the photodetector.

17. An electronic device comprising:
an energy storage device;
communication circuitry; and
a touch screen including:
a micro-driver region corresponding to a chiplet micro-driver and a photodetector region corresponding to a photodetector;
a first layer of opaque material extending through the micro-driver region and the photodetector region, the first layer of opaque material including a plurality of openings in the micro-driver region and the photodetector region including a first opening in the micro-driver region opposite the chiplet micro-driver and a second opening in the photodetector region opposite the photodetector; and
a plurality of metal layers between the first layer of opaque material and the chiplet micro-driver and the photodetector, wherein one or more first portions of one or more of the plurality of metal layers are disposed opposite the first opening and configured to at least partially block light entering the first opening from being incident on the chiplet micro-driver.

18. The electronic device of claim 17, wherein each of the one or more first portions of the one or more of the plurality of metal layers opposite the first opening has a dimension smaller than a dimension of the first opening.

19. The electronic device of claim 17, wherein the one or more first portions of the one or more of the plurality of metal layers include a first routing trace in a first metal layer and a second routing trace in a second metal layer, different from the first metal layer, the first routing trace overlapping the second routing trace by a first predetermined amount.

20. The electronic device of claim 17, wherein a first metal layer of the one or more of the plurality of metal layers is a micro-driver metal layer configured to route micro-driver signals and a second metal layer of the one or more of the plurality of metal layers is a panel metal layer configured to route signals other than micro-driver signals.
